(19) United States
(12) Patent Application Publication
(10) Pub. No.: US 2016/0301964 A1
(43) Pub. Date: Oct. 13, 2016

(54) INTERNET STREAMING CONTENT DELIVERY SYSTEM AND METHOD

(71) Applicant: Investel Capital Corporation, Vancouver (CA)

(72) Inventor: Benoit Laliberte, Mont St-Hilaire (CA)

(21) Appl. No.: 14/993,661

(22) Filed: Jan. 12, 2016

Related U.S. Application Data
(63) Continuation of application No. PCT/CA2014/050628, filed on Jul. 2, 2014.
(60) Provisional application No. 61/845,566, filed on Jul. 12, 2013.

(51) Int. Cl. H04N 21/2547; H04N 21/482; H04N 21/643; H04N 21/472; H04N 21/24

(52) U.S. Cl. CPC H04N 21/2547; H04N 21/47202; H04N 21/2407; H04N 21/64322; H04N 21/482

(57) ABSTRACT

Described are various embodiments of a system and method in which content may be delivered embedded within streaming programming contents over Internet, to be selectively viewed concurrently therewith by subscribers in exchange for compensation. For example, compensation may be provided in the form of a subscription fee reduction, wherein incrementally accumulated ad viewing credits can be applied against a subscriber's next invoice or statement.

### FIELD OF THE DISCLOSURE

The present disclosure relates to Internet streaming content delivery, such as via WebTV and Internet Protocol TV (IPTV) systems, and, in particular, to an Internet streaming content delivery system and method, and a content delivery method therefor.

### BACKGROUND

Internet Protocol Television (IPTV) broadcasting systems are becoming increasingly popular, delivering multimedia (e.g. audio/visual) content to subscribers around the globe via an Internet connection. In general, IPTV is a system through which television services are delivered using the Internet protocol suite over a packet-switched network such as the Internet, instead of being delivered through traditional terrestrial, satellite signal, and cable television formats. Using this format, greater flexibility and interactivity may be provided to users as compared to traditional television broadcasting techniques. Similar system architectures are also used to provide WebTV services, for example over an Internet connection to a user's personal computer (PC) or wireless device.

Different services may include, but are not limited to, live television broadcast, time-shifted broadcasts, and video-on-demand (VOD) broadcast, each service delivering streaming multimedia content along with, in some examples, interactive features and/or functions, across an access agnostic, packet switched network that employs the IP protocol to transport the audio, video and control signals. Subscriber-based IPTV models generally employ telecommunications networks with high-speed access channels into end-user premises via set-top boxes (STB) or other customer-premises equipment, i.e. such as IPTV-ready televisual equipment. Customers, at their end, will generally pay a subscription fee for the service they receive, which may vary on the amount or variety of content they may wish to access, different service packages, and the like.

As with traditional television broadcasting systems, content plays an important role in the economics of IPTV broadcasting, and generally takes the form of traditional audio/visual content or ads nested periodically between segments of selected programing to be viewed by end users.

The provision of Internet-based broadcasting has opened the door to new concepts and flexibilities in content delivery, advertising and subscription packages. For example, in US Patent Application Publication No. 2013/0117783, pay-per-view programming is delivered to an IPTV or personal computer (PC) for a fee, unless a customer has previously consented to viewing advertising materials, in which case the programming is delivered free of charge and selected advertising materials are inset within the delivered programming via screen-splitting technology.

A similar approach was reported in a Forbes magazine article published Mar. 1, 2013 and titled: Watch Ads, Get Paid: Is This The Future Of Ad-Supported Content? (http://www.forbes.com/sites/jjcolao/2013/03/01/watch-ads-get-paid-is-this-the-future-of-ad-supported-content/). In this article, a company is reported to provide a pay-per-view model in which customers may select to pay for each content item directly, or accumulate credits by previously viewing content, which credits can then be used to purchase a content item for viewing.

In US Patent Application Publication No. 2007/0107011, service level differentiation in an IPTV delivery system is described, wherein subscribers may choose to pay lower or higher subscription fees for IPTV services in exchange for being exposed to less or more content, respectively, or again to gain access to value-added content. In general, this technique allows a subscriber to select a payment level at the onset in exchange for different viewing privileges, in one case selecting the amount of content they will be exposed to.

This background information is provided to reveal information believed by the applicant to be of possible relevance. No admission is necessarily intended, nor should be construed, that any of the preceding information constitutes prior art.

### SUMMARY

The following presents a simplified summary of the general inventive concept(s) described herein to provide a basic understanding of some aspects of the invention. This summary is not an extensive overview of the invention. It is not intended to restrict key or critical elements of the invention or to delineate the scope of the invention beyond that which is explicitly or implicitly described by the following description and claims.

A need exists for an Internet streaming content delivery system and method, and content delivery method therefor, that overcome some of the drawbacks of known techniques, or at least, provides a useful alternative thereto. Some aspects of this disclosure provide examples of such systems and methods.

In accordance with one aspect, there is provided a method for delivering content over an Internet streaming content delivery system, the method comprising: providing subscribers selective access, via a subscriber terminal, to programming content over an IP network in either of an original programming content stream and an embedded programming content stream; receiving, from a given subscriber terminal, remote selection of given programming content in either of said original programming content stream and said embedded programming content stream; in response to said remote selection being for said original programming content stream, streaming said given programming content to said given subscriber terminal in original format; in response to said remote selection being for said embedded content programming stream, streaming said given programming content to said given subscriber terminal in an embedded format, wherein the content is embedded with said given programming content to be viewed streaming concurrently therewith; tracking viewing by said given subscriber of said embedded content programming stream over time; and incrementally allocating compensation credits to an account of said given subscriber as a function of said tracked viewing.

In accordance with another aspect, there is provided An IPTV system for delivering streaming content over a communication network for consumption by a plurality of subscribers via respective subscriber devices, the system comprising: a plurality of set top boxes each operable to interface with a respective subscriber device; a content management interface rendered via said set top boxes on each said respective subscriber device and providing subscribers selective access to programming content over the network in either of an original programming content stream and an embedded programming content stream; a streaming server communicatively linked to said content management interface to receive a given subscriber selection from a given set top box, and stream a selected programming content thereto in a selected one of said original programming content stream and said embedded programming content stream in response thereto; an encoder embedding content with said selected programming content prior to streaming by said streaming server to said given set top box, said embedded content encoded to be viewed streaming concurrently with said selected programming content; an account management system tracking broadcast of said embedded stream to said given set top box and allocating incremental subscriber credits to said given subscriber as a function thereof.

In accordance with another aspect, there is provided an Internet streaming content delivery system comprising: means for providing users selective access, via a user terminal, to programming content over an IP network in either of an original programming content stream and an embedded programming content stream; means for receiving, from a given user terminal, remote selection of given programming content in either of said original programming content stream and said embedded programming content stream; means for streaming said given programming content to said given user terminal in an embedded format in response to said remote selection being for said embedded content programming stream; means for embedding content with said given programming content to be viewed streaming concurrently therewith via said given user terminal; means for tracking said streaming in said embedded format over time to said given user terminal; and means for incrementally allocating user credits to a user of said given user terminal as a function of said tracked viewing.

In accordance with another aspect, there is provided a computer-readable medium having statements and instructions stored thereon for implementation by a processor of a computing system to manage delivery of content over an Internet streaming content delivery system by: providing subscribers selective access, via a subscriber terminal, to programming content over an IP network in either of an original programming content stream and an embedded programming content stream; receiving, from a given subscriber terminal, remote selection of given programming content in either of said original programming content stream and said embedded programming content stream; in response to said remote selection being for said original programming content stream, commanding streaming of said given programming content to said given subscriber terminal in original format; in response to said remote selection being for said embedded programming stream, commanding streaming of said given programming content to said given subscriber terminal in an embedded format, wherein the content is embedded with said given programming content to be viewed streaming concurrently therewith; tracking viewing by said given subscriber of said embedded programming stream over time; and incrementally allocating compensation credits to an account of said given subscriber as a function of said tracked viewing.

In accordance with another aspect, there is provided an Internet streaming content delivery system comprising: a user interface to be rendered on a user terminal in providing users selective access to programming content over an IP network in either of an original programming content stream and an embedded programming content stream; an access management server in communication with said user interface to receive, from a given user terminal, remote selection of given programming content in either of said original programming content stream and said embedded programming content stream; one or more streaming servers streaming said given programming content to said given user terminal in an embedded format in response to said remote selection being for said embedded content programming stream; one or more encoders operatively coupled to said one or more streaming servers to embed content with said given programming content to be viewed streaming concurrently therewith via said given user terminal; a view tracker to track said streaming in said embedded format over time to said given user terminal; and a user account interface to said tracker to incrementally allocate user credits to a user of said given user terminal as a function of said tracked viewing.

In accordance with one aspect, the systems and methods described herein overcome technical challenges in the provision and tracking of content viewings by users of an internet streaming content delivery system.

In accordance with another aspect, the systems and methods described herein overcome technical challenges in providing alternative and/or flexible subscriber payment methods and devices for the provision of streaming content over Internet.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a diagram of an Internet streaming content delivery system and method, in accordance with one embodiment of the invention;

FIG. 2 is a diagram of an exemplary broadcasting management system, and advertisement content stream allocation mechanism associated therewith, in accordance with one embodiment of the invention;

FIGS. 3A and 3B provide, in combination, a process flow diagram for operation of the system, such as those shown in FIGS. 1 and 2, in accordance with one embodiment of the invention; and

FIGS. 4A and 4B are diagrammatic screen shots of streaming original format programming content and streaming embedded-advertising format programming content, in accordance with one embodiment of the invention.

### DETAILED DESCRIPTION

The systems and methods described herein provide, in accordance with different embodiments, different examples in which advertising content may be delivered to IPTV and/or WebTV subscribers (commonly referred to herein as Internet streaming content delivery system, or ISCD, subscribers), to be viewed concurrently with streaming programming contents, in exchange for compensation. For example, compensation may be provided in the form of a subscription fee reduction, wherein accumulated advertisement viewing credits accumulated over a payment cycle or period are applied against a subscriber's next invoice or statement. In one such example, a subscriber may select, during a given viewing period, to receive concurrent broadcast of advertising materials with selected content, for example inset via a split-screen or picture-in-picture

(PIP) broadcast, in exchange for compensation measured, in one example, as a function of a viewing period or duration. Accordingly, subscription fees may be incrementally lowered as a function of incremental increases in overall concurrent/embedded advertising viewings. Where advertising viewing compensation exceeds a preset subscription fee, the below described methods and systems, in some embodiments, may be configured to provide an automatic payment to the subscriber in the form of cash or redeemable rewards extrinsic to the ISCD system. Alternatively, overcompensations may be allocated to overall subscription fees for packaged telecommunication services, for example where an ISCD system subscription is packaged with in-home Internet services, home phone services such as VoIP, cellular phone services (e.g. applied to a voice, data or other such cellular service package), and the like.

These and other applications will be described in greater detail below, in a non-restrictive manner, with reference to the below description of exemplary embodiments.

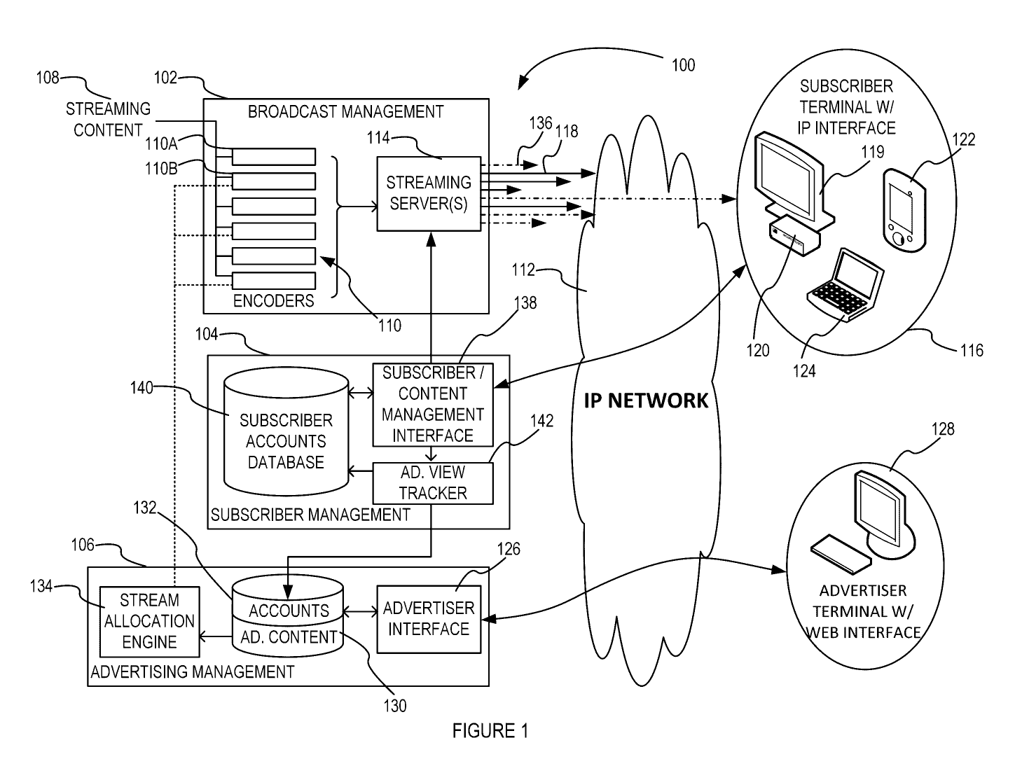

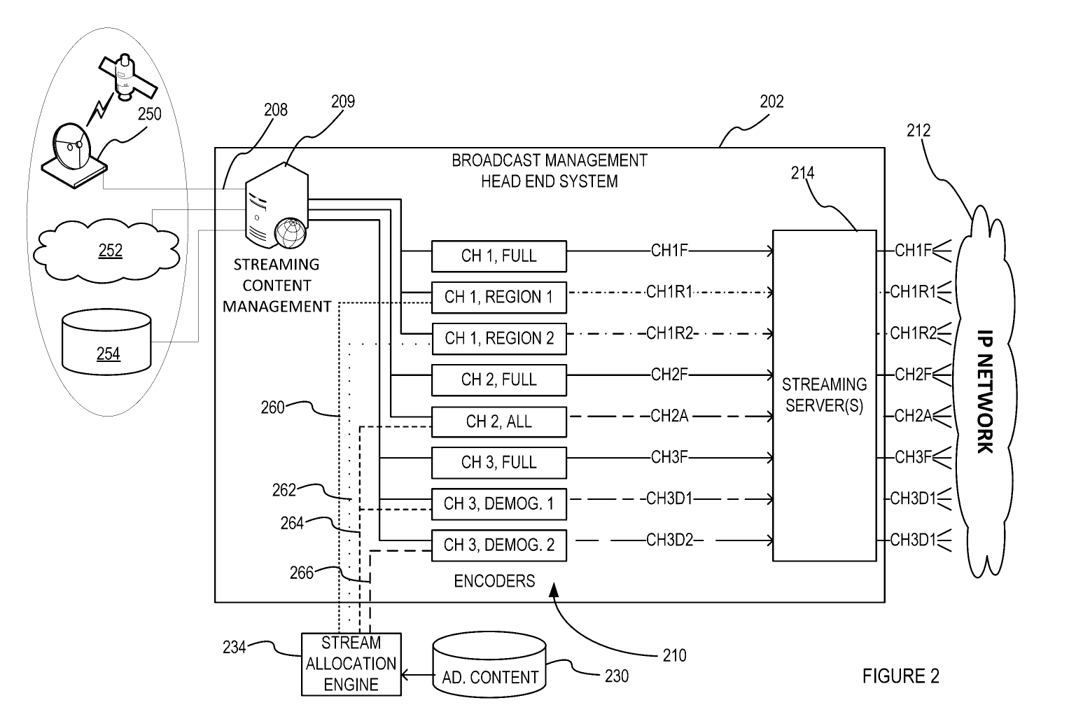

With reference now to FIG. 1, and in accordance with one embodiment, an example of an ISCD system 100 will now be described. The system 100 generally comprises a broadcast management system or module 102, a subscriber management system or module 104, and an advertising management system or module 106. The broadcast management system 102 is generally configured to receive as input streaming content 108 sourced, for example, from an external content provider. As will be discussed with reference to FIG. 2, streaming content may be received via a satellite downlink or a fiber optic link from an external live content provider, or again from a local or external content repository in providing access to stored content.

The streaming content 108 is fed to a set of encoders 110 (e.g. encoding engines and/or servers, etc.) configured to encode respective channels or subchannels of the streaming content 108 into a selected format appropriate for delivery over an Internet Protocol (IP) network 112, such as Internet. In this embodiment, and as will be described in greater detail below, each programming content stream is independently encoded both as an original format or full screen programming content stream (e.g. encoder 110A), and as one or more embedded advertisement format (e.g. ad-split or nested screen) programming content streams (e.g. encoder 110B). Accordingly, a subscriber may select to view the original/full screen version of the selected programming contents, or select to view an ad-split or nested screen version thereof in return for incremental compensation, such as incremental credits applied to their account (e.g. based on ad viewing time and associated rates).

Each encoded content stream is then fed to one or more streaming servers 114 to be broadcast to respective subscriber terminals 116 over the IP network 112. In one embodiment, as will be described in greater detail below, respective original and embedded content streams 118, 136 are provided via unicast broadcasting in pushing a dedicated content stream to each active subscriber via a respective subscriber IP address, which also facilitates real-time viewership tracking given the one-to-one nature of unicast broadcasting. In such embodiments, up to four thousand viewers can be serviced by a single streaming server 114. In another embodiment, multicast broadcasting may be employed, whereby multiple copies of a same content stream are indiscriminately made accessible to a group of subscribers via a common TCP/IP port. In multicast embodiments, a single streaming server may advantageously service up to twenty thousand viewers, however, at least part of the viewership tracking function must be transferred to the subscriber terminal 116, for example via an application running thereon or operated in association therewith.

Examples of subscriber terminals 116 may include, but are not limited to, traditional television sets 119 having an associated IPTV STB 120, IPTV-compliant television sets (not shown), smartphones 122 such as iPhone™, Blackberry™ or Android™ devices, laptops 124 or traditional desktop computers, tablets (not shown) and the like.

The system's advertising management system or module 106 generally comprises an advertiser interface 126, such as a Web interface, to provide advertisers access via respective advertiser terminals 128 (e.g. web-enabled computing device such as laptop or desktop computer, tablet, smartphone, etc.), to an advertising management platform in which advertising placements and timeslots can be purchased, and accounts associated therewith, managed. For example, an advertiser may access the system 106 via interface 126 to upload advertising contents for storage in advertising content database 130, and select advertising targets (e.g. timeslots, channels, demographics, etc.) to be associated therewith. The interface 126 further enables advertisers to manage their accounts, for example stored within accounts management database 132, with the broadcaster. For instance, funds may be transferred electronically via the interface 126 so to set an initial advertising campaign budget or replenish funds to be allocated to the broadcaster for specific ad placements and/or subscriber views over a dedicated time period.

The ad contents and targets can then be managed through a programming content stream allocation engine 134 in associating specific ad contents with selected programming streams based on identified targets, and/or based on one or more competitive advertisement placement processes whereby different advertisers compete for coveted advertisement placements. Upon allocation with respective content streams by engine 134, ad contents (e.g. static images, text and/or frames in .jpg or .gif formats) are fed through corresponding encoders 110 (e.g. encoder 110B) concurrently with their allocated stream to be embedded therein, for example, in the form of ad banners, ribbons, tabs, picture-in-picture (PIP), watermarks, or the like. In one example, selected ad content is provided in the form of an image, and sequentially embedded within multiple programming content frames to provide a static ribbon or banner partially circumscribing each frame for a preset ad duration (e.g. 6 seconds) or throughout a given program. Other embedding examples will be appreciated by the person of ordinary skill in the art, and are therefore intended to fall within the scope of the present disclosure. Ads-free streams on the other hand, are processed independently (e.g. via encoder 110A) and are thus devoid of embedded ad contents, as introduced above and as will be discussed in greater detail below.

In one embodiment, each encoder consists of an open source encoding engine/server, such as VLC (VideoLAN Organization), that merges a selected content stream with its allocated ad content in generating an embedded stream 136 for broadcast. Using this approach, the embedded stream cannot be readily separated or altered by the subscriber, thus ensuring ad contents are displayed as originally intended during the encoding process. In one such example, each encoder provides h.264 encoding over an mpeg4 carrier, thought it will be appreciated that other standards, such as mpeg2 and the like, may also be considered without departing from the general scope and nature of the present disclosure. Different stream allocation techniques for allocating ad contents to different content channels based on content, demographics and/or geography, to name a few, will be described further below with reference to FIG. 2.

The subscriber management system or module 104 comprises a subscriber/content management interface 138, such as for example, a Web interface accessible through a standard Web browser (WebTV), or again a dedicated IPTV or WebTV interface rendered via an IPTV STB 120 or dedicated ISCD application running on other types of subscriber terminals 116. The subscriber interface 138 is configured to confirm the subscription status of the user (e.g. automatically and/or via a standard login process) with a database of subscriber accounts 140, receive selection of desired programming content from active subscribers, and communicate this selection to the streaming server(s) 114, which, in this embodiment (unicast broadcasting), routes selected contents to the subscribers' respective IP addresses for viewing. Subscriber content selections can be tracked via the subscriber interface 138 and/or streaming server(s) 114, and embedded ads thereby viewed by the subscriber illustratively tracked by tracker 142. Namely, by tracking the particular content stream viewed by the subscriber over time, the tracker 142, in one embodiment consisting of a call video recorder (CVR) or the like, can not only monitor advertising fees to be drawn from the advertisers' accounts 132 based on actual viewership, but also track ad views by the subscriber to apply a corresponding credit to the subscriber's account 140. For example, a subscriber ad view credit rate (e.g. amount per hour or 10 minute slice) may be associated with each ad placement (e.g. based on a preset percentage of an adverting fee rate, or a preset rate) such that, as the subscriber views a selected advertisement-enhanced content stream over time, ad-viewing credits are incrementally applied to their account in accordance with the prescribed credit rate associated with this stream. As will be appreciated by the skilled artisan, while the application of a view tracker is not as readily achievable at the head end for multicast broadcasting, a dedicated ISCD application or STB function may be configured to periodically report back viewership data to the subscriber management system (e.g. every few minutes) in providing similar results.

Referring now to FIG. 2, and in accordance with one illustrative embodiment of the invention, an exemplary broadcasting management head end system, and advertisement content stream allocation mechanism associated therewith, will now be described. In this embodiment, the management head end system 202 is again generally configured to receive as input streaming content 208 sourced, for example, from an external content provider. For example, content 208 may be received and managed by a streaming content management server 209, and sourced from a satellite downlink 250 (e.g. form a broadcasting station or channel), over the Web 252, or again from a local or remote storage device 254 (e.g. stored content, such as video-on-demand (VoD) content).

The streaming content 208 is fed to a set of encoders 210 (e.g. encoding engines and/or servers, etc.) configured to encode respective channels or subchannels of the streaming content 208 into a selected format appropriate for delivery over an Internet Protocol (IP) network 212, such as Internet. As introduced above, each programming content stream or channel is independently encoded both as an original format or full screen programming stream (e.g. streams CH1F, CH2F and CH3F respectively produced via encoders CH1, FULL; CH2, FULL; and CH3, FULL), and as one or more embedded advertisement (e.g. ad-split) streams (e.g. streams CH1R1; CH1R2; CH2A; CH3D1; CH3D2 respectively produced via encoders CH1, REGION 1; CH1, REGION 2; CH2, ALL; CH3, DEMOG.1; CH3, DEMOG.2). Accordingly, a subscriber may select to view the full screen version of the selected programming contents, or select to view an ad-split screen version thereof in return for incremental compensation credits to be applied to their account as a function of incremental ad viewing time and an ad viewing credit rate associate therewith.

In this example, different ad-split streams are generated as a function of selected streaming channels, subscriber geography and demographics. For example, advertisers in this embodiment, upon uploading ad contents to the ad content database 230, also set advertising targets (e.g. in the context of a customized advertising campaign) to be managed by a stream allocation engine 234 in embedding ad contents to appropriate content streams. In this particular example, ad content 260 is allocated to the channel 1 stream for subscribers located in region 1 and thus fed to encoder CH1, REGION1 to produce embedded content stream CH1R1, whereas ad content 262 is allocated to the channel 1 stream for subscribers located in region 2 and thus fed to encoder CH1, REGION2 to produce embedded content stream CH1R2. Similarly, ad content 264 is allocated to the channel 2 stream for all subscribers and thus fed to encoder CH2, ALL to produce embedded content stream CH2A, and also allocated to the channel 3 stream for subscribers satisfying a first set of demographic criteria only, i.e. fed to encoder CH3, DEMOG.1 to produce embedded content stream CH3D1. Finally, ad content 266 is allocated to the channel 3 stream for subscribers satisfying a second set of demographic criteria (or again for all “other” demographics) and fed to encoder CH3, DEMOG.2 to produce embedded content stream CH3D2.

Each encoded full screen and ad-split stream is then fed to one or more streaming servers 214 for broadcast over IP network 212. Depending on the subscriber's location (e.g. accessed via the subscriber's IP address and/or account settings), demographics (e.g. accessed via the subscriber's account settings, history and/or viewing habits), and content selection, targeted advertising may be delivered thereto via an embedded stream, generating both advertising revenue for the broadcaster and incremental subscription credits for the subscriber, and providing a targeted reach for advertisers.

As will be appreciated by the skilled artisan, the illustrated embodiment of FIG. 2 is provided as an example only, as other ad content allocation and encoding techniques may also be applied to achieve similar results. Namely, the different examples shown in FIG. 2 are provided for illustrative purposes only, and should not be considered as limiting to the diversity of encoding and allocation schemes available within the present context.

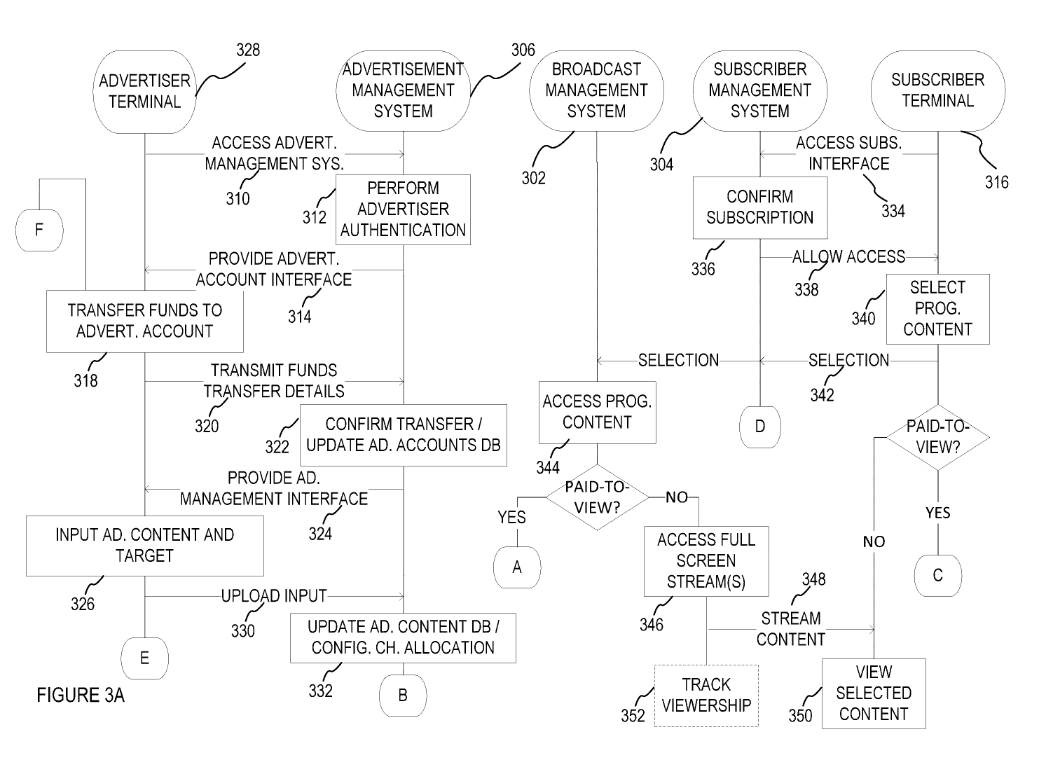

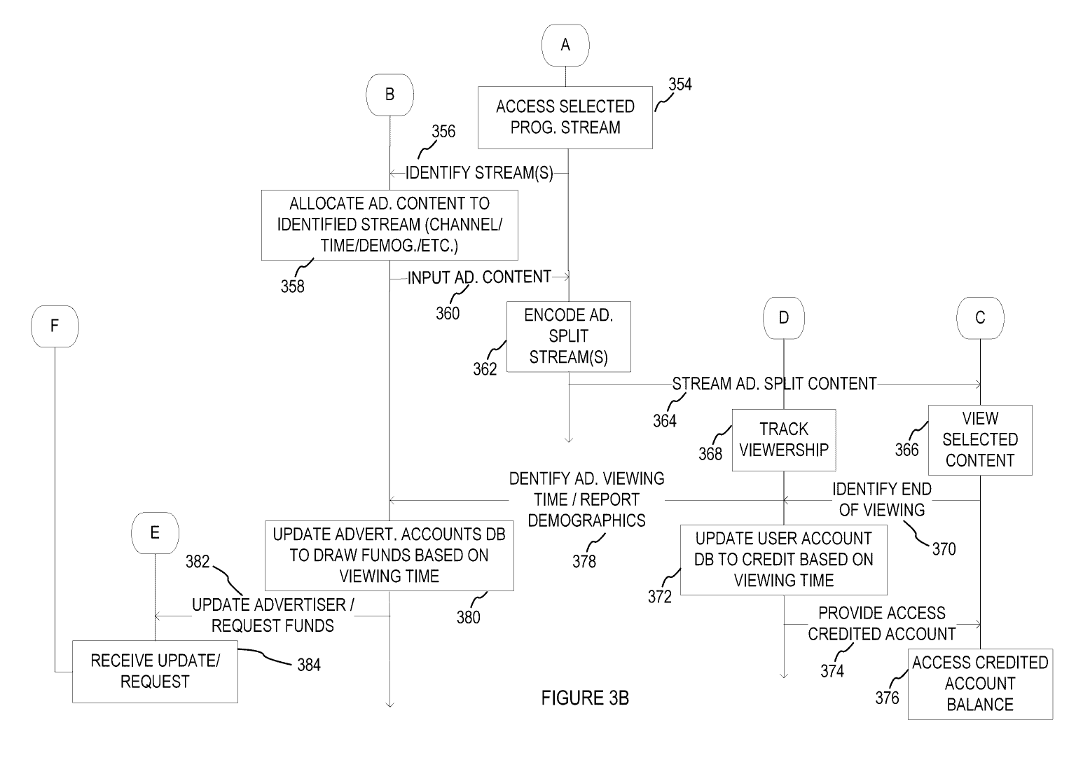

Referring now to FIGS. 3A and 3B, and in accordance with one embodiment, a process flow diagram for operating exemplary embodiments of the systems of FIGS. 1 and 2, will now be described. In this embodiment, interactions between the advertiser terminal 328, advertisement management system 306, broadcast management system 302, subscriber management system 304 and subscriber terminal 316 are presented in one illustrative sequence, though it will be appreciated that other sequences, as can other features and functions be considered without departing from the general scope and nature of the present disclosure. Further, while certain actions and functions are generically associated with different components of the system in the illustrated embodiment, these or similar functions may be implemented by other components of the system, or shared therebetween in providing similar results. These and other such considerations are therefor considered to fall within the scope of the present disclosure.

In this embodiment, the advertiser terminal 328 requests access to the advertisement management system 306 at step 310, which performs advertiser authentication at step 312 (which may include the generation of a new account and/or authentication of an existing account). Upon authentication, the advertiser terminal 328, in this example, is first directed to an advertiser account interface at step 314, though which a funds transfer to the broadcaster can be coordinated at step 318 and executed at step 320 to support a new or ongoing advertising campaign. In other embodiments, the account interface may alternatively be accessed only once the campaign has been designed and an appropriate advertising fee has been set, or again available as an option throughout the campaign design process.

Once the funds transfer has been confirmed at step 322, the advertiser is provided access to an advertisement (i.e. ad campaign) management interface 324. Using this interface, the advertiser may select and upload ad contents and targets at step 326 in defining a particular ad campaign to be implemented by the broadcaster with its subscribers. Contents (e.g. images, frames, watermarks, symbols, logos, text, etc.) and target inputs (e.g. demographics, programming contents, geographic settings such as postal/zip/area codes, etc.) are uploaded to the system 306 at step 330 to update the ad content database and configure the channel allocation engine at step 332 to implement the newly created or updated ad campaign.

From the perspective now of the subscriber using subscriber terminal 316, the subscriber requests access at step 334 to the subscriber management system 304 (e.g. via stored or input login credentials, or again automatically via activation of a client application interface), which confirms subscription credentials (e.g. username and password, client IP address, client device ID, etc.) at step 336, and allows the subscriber access at step 338 to a ISCD interface. Using this interface, the subscriber may select particular programming content (e.g. select particular channel, item from a programming schedule or grid, stored VoD programming, etc.) at step 340, which selection also confirms whether such programming content is to be viewed in full screen format, or in an ad-split-screen format in exchange for subscription fee credits.

The content selection is communicated to the broadcast management system 302 at step 342 (directly or via subscriber management system 304), and the selected programming content accessed accordingly at step 344 for broadcast. In the event that the subscriber selection is directed to the full screen format of the content (e.g. where a paid-to-view option is not selected), the full screen stream of the selected content is accessed at step 346 by the broadcast system 302 and streamed at step 348 to the subscriber terminal 316, from which the content can be viewed at step 352. Optionally, content viewing by the subscriber can be concurrently tracked (e.g. in real-time) at step 350 (e.g. for billing or reporting purposes, etc.).

On the other hand, where a paid-to-view option has been selected by the subscriber, the process proceeds through connectors (A) of FIGS. 3A and 3B, whereby the broadcasting system 302 proceeds to access the selected programming stream at step 354, and concurrently access relevant ad content from the allocation engine to produce the selected embedded split-screen content stream. To do so, the particular content stream is identified to the ad management system 306 (or stream allocation engine thereof) at step 356, optionally along with geographic and/or demographic information relevant to ad content selection, from which corresponding ad content is identified and allocated to the identified stream at step 358. The allocated ad content is fed to a corresponding encoder of the broadcast management system 302 at step 360, and embedded within the selected programming stream during encoding step 362. The ad-split content is then streamed to the subscriber terminal 316 at step 364 for viewing. While the above contemplates an on-demand encoding process, the system may rather automatically encode the whole set of available original format and embedded format content streams irrespective of demand, and stream appropriate contents to subscribers upon selection. This may be particularly relevant where encoding engines or servers are designated for subscribers in certain geographical areas and/or satisfying certain demographics, and can therefore be operated irrespective of demand for the ready upon subscriber selection.

At step 368, ad viewing is tracked (e.g. via a video call recorder) as concurrent subscription fee credits are incrementally accumulated in favor of the subscriber. When the subscriber ceases to view the ad-split content at step 370, or again upon the subscriber making another ad-view content selection, accumulated credits are applied to the subscriber's account at step 372, and made accessible to the subscriber at step 374 for viewing at step 376. Alternatively, ad-view credits may be applied in real-time while viewing in ongoing.

In parallel, ad viewing times (and optionally viewership demographics and/or geography) are reported to the ad management system 306 at step 378, which report is used to update the advertiser's accounts at step 380 and draw funds therefrom accordingly as ad revenues to the broadcaster. The advertiser is updated periodically or in real-time at step 382, for example in the form of an advertising campaign results summary, at which point additional funds may be requested to supplement an ongoing campaign, or in the formation of a new campaign. The advertiser receives the update and/or fund request at step 384, and repeats the process from step 318.

Using the above-described process and alternatives thereto, subscribers are provided direct access to programming content with the option of viewing such programing content in a full screen or ad-split-screen format. Where a full screen format is selected, viewing permissions and subscription fees associated therewith are applied as per the subscriber's original service contract agreement. On the other hand, where a subscriber selects to view the same content with embedded advertising concurrently displayed therewith during the regular course of the streaming programming content, subscription fee credits may be incrementally accumulated and applied to the subscriber's account, or again paid back directly to the subscriber. Where the ISCD system is provided to the subscriber in the context of a multiple service subscription package (e.g. in combination with Internet (DSL/cable) access, telephone services (e.g. V0IP), etc.), subscription credits may be applied to the subscription package as a whole, thereby effectively allowing subscribers to save on the associated services by watching more concurrent embedded ad content with their selected programming content.

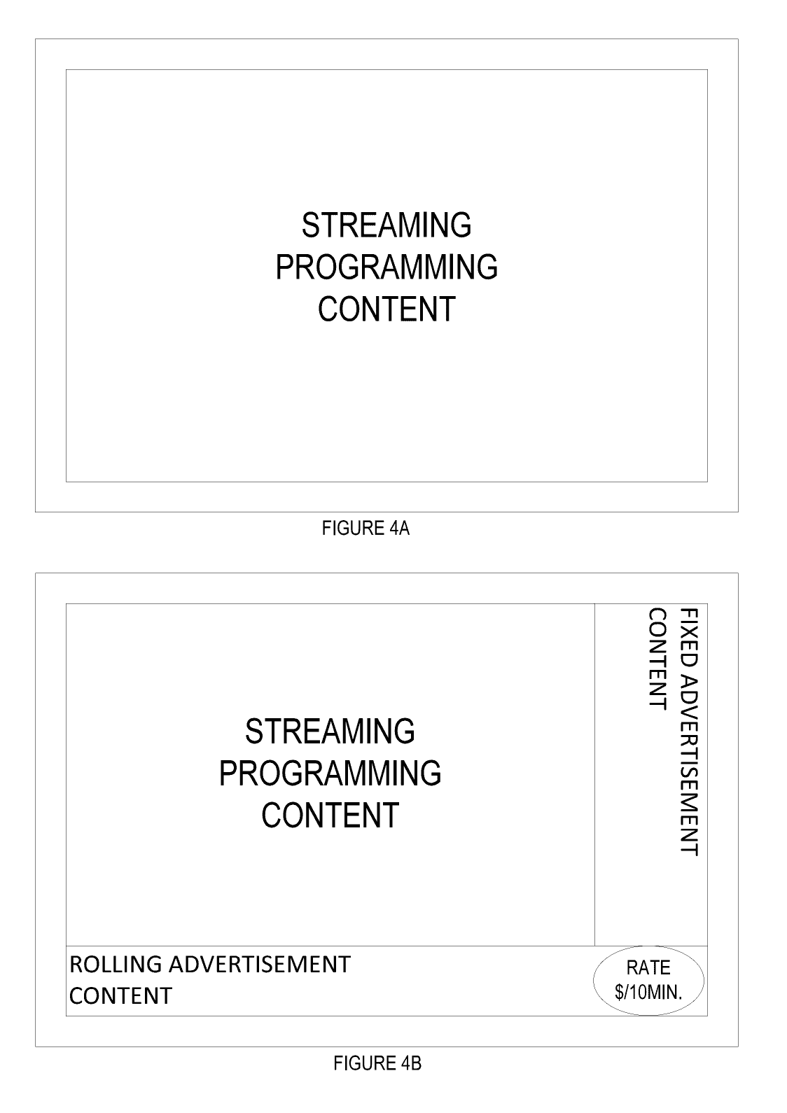

FIGS. 4A and 4B provide comparative exemplary screen shots as viewed by a subscriber, in accordance with one embodiment of the invention. In FIG. 4A, the subscriber has selected a full screen format, and is thus provided with streaming contents in full screen (i.e. without adds), in accordance with the terms of his subscription agreement. In FIG. 4B, the subscriber has selected to view embedded ad content concurrently with regular programming content, in the form of banner or ribbon ads. In this example, the programming content is streamed unobstructed in one frame, with a fixed advertisement ribbon and rolling advertisement banner embedded in adjacent frames. Given the embedded nature of this advertising campaign, a subscriber may not readily alter his viewing experience to block or otherwise extract the ad content, and is thus committed to viewing the ad content.

An ad viewing credit rate is also displayed embedded within the stream as an indication to the subscriber as to the rate at which subscription credits may be accumulated for this particular content selection. Accordingly, a subscriber may decide that, for certain content selections, ad viewing credits are not particularly beneficial and switch back to a full screen format. This subscriber could nonetheless receive credit for the time spent watching the ad-split format even if the entire programming content was not viewed in that format. Similarly, a subscriber may choose to view high-return ad-split programming in offsetting heavy subscription fees. Along those lines, advertisers may be inclined to increase ad spending to attract a larger viewership.

Furthermore, as discussed above, using geographic and/or demographic data to target ad placements, subscribers may be subject to more relevant ad placements, while advertisers may gain access to a more relevant subscriber pool. For example, local advertising may be more readily applied to national broadcasts, whereby each local advertiser may commit to a reduced advertising fee in exchange for limited local viewership.

In one embodiment, subscriber selection as to the viewing of embedded ad contents is made centrally via a dedicated switch (e.g. software/firmware selection on the subscriber interface). In other embodiments, the broadcasting system may be preconfigured to provide programming on distinct streaming channel sets, wherein a first set of channels is designated for full screen or original format viewing, whereas a second corresponding set of channels is designated for split screen viewing. For example, all programming streaming on channel 107 could be designated for full screen viewing, whereas programming streaming on channel 507 could be designated for split-screen or embedded advertising viewing. Accordingly, a subscriber need only select between channel sets to make a selection as to whether they wish to watch embedded add contents and receive accumulating credits, or if they would rather watch the full screen version of selected programming. Similarly, since channels for the same programming content are recognizably associated with one another, selection of one or the other is facilitated when seeking a specific counterpart to a given channel selection. In the same vein, a subscriber could selectively switch between streams mid-program or between programs, while still receiving corresponding credits for time when tuned into the split screen stream.

In one embodiment, the system is also configured to probe the viewer during programming and/or track user activity to ensure programming, and embedded advertising, is being watched and not simply left to stream unattended in accumulating subscription credits. This may be implemented by tracking subscriber actions via a remote control, peripheral or touch screen interface of the subscriber terminal, or again periodically probing for subscriber action to confirm viewership. Such actions may also be automatically processed to discriminate between human actions and those more likely associated with an automated engine run to mimic subscriber actions and thus tamper with the ad view benefits system.

While the present disclosure describes various exemplary embodiments, the disclosure is not so limited. To the contrary, the disclosure is intended to cover various modifications and equivalent arrangements included within the general scope of the present disclosure.

What is claimed is:

1. A method for delivering embedded content over an Internet streaming content delivery system, the method comprising:
providing subscribers selective access, via a subscriber terminal, to programming content over an IP network in either of an original programming content stream and an embedded programming content stream;
receiving, from a given subscriber terminal, remote selection of given programming content in either of said original programming content stream and said embedded programming content stream;
in response to said remote selection being for said original programming content stream, streaming said given programming content to said given subscriber terminal in original format;
in response to said remote selection being for said embedded programming content stream, streaming said given programming content to said given subscriber terminal in an embedded format, wherein the embedded content is embedded with said given programming content to be viewed streaming concurrently therewith;
tracking viewing by said given subscriber of said embedded programming content stream over time; and
incrementally allocating compensation credits to an account of said given subscriber as a function of said tracked viewing.

2. The method of claim 1, further comprising:
incrementally drawing revenue from one or more accounts associated with said embedded content as a function of said tracked viewing time.

3. The method of claim 1, wherein said streaming comprises unicast broadcasting of said given programming content, and wherein said tracking comprises tracking a unicast broadcasting stream pushed to an IP address of said given subscriber terminal.

4. The method of claim 1, wherein said embedded programming content stream and said original programming stream are associated with respective streaming content channels recognizably associated with one another to facilitate selection of one or the other by said given subscriber upon seeking access to said given programming content.

5. The method of claim 1, wherein said embedded format comprises a split-screen format.

6. The method of claim 5, wherein said split-screen format comprises at least one of a static frame and a rolling frame.

7. The method of claim 1, wherein said embedded programming content stream is selected from two or more such streams based on at least one of a geographic area and demographics of the subscriber.

8. The method of claim 1, wherein said tracking comprises tracking discrete viewing time segments of duration lesser than a programming content duration, and wherein said allocating comprises allocating a fixed compensation credit for each of said viewing time segments.

9. The method of claim 1, wherein said compensation credit comprises a subscription fee credit to be applied against subscription fees of said given subscriber.

10. The method of claim 1, further comprising periodically monetarily compensating said given subscriber as a function of said allocated compensation credits.

11. An IPTV system for delivering streaming content over a communication network for consumption by a plurality of subscribers via respective subscriber devices, the system comprising:
a plurality of set top boxes each operable to interface with a respective subscriber device;
a content management interface rendered via said set top boxes on each said respective subscriber device and providing subscribers selective access to programming content over the network in either of an original programming content stream and an embedded programming content stream;
a streaming server communicatively linked to said content management interface to receive a given subscriber selection from a given set top box, and stream a selected programming content thereto in a selected one of said original programming content stream and said embedded programming content stream in response thereto;
an encoder embedding content with said selected programming content prior to streaming by said streaming server to said given set top box, said embedded encoded to be viewed streaming concurrently with said selected programming content;
an account management system tracking broadcast of said embedded stream to said given set top box and allocating incremental subscriber credits to said given subscriber as a function thereof.

12. The system of claim 11, wherein each of the subscribers is accountable for paying subscription fees to access the streaming content over the communication network, and wherein said subscriber credits are automatically applied to incrementally offset those fees.

13. The system of claim 11, wherein said streaming server comprises a unicast broadcasting server, and wherein said account management system tracks streaming content pushed to an IP address associated with said given set top box.

14. A computer-readable medium having statements and instructions stored thereon for implementation by a processor of a computing system to manage delivery of embedded content over an Internet streaming content delivery system by:
providing subscribers selective access, via a subscriber terminal, to programming content over an IP network in either of an original programming content stream and an embedded programming content stream;
receiving, from a given subscriber terminal, remote selection of given programming content in either of said original programming content stream and said embedded programming content stream;
in response to said remote selection being for said original programming content stream, commanding streaming of said given programming content to said given subscriber terminal in original format;
in response to said remote selection being for said embedded programming stream, commanding streaming of said given programming content to said given subscriber terminal in an embedded format, wherein the content is embedded with said given programming content to be viewed streaming concurrently therewith;
tracking viewing by said given subscriber of said embedded programming stream over time; and
incrementally allocating compensation credits to an account of said given subscriber as a function of said tracked viewing.

15. The computer-readable medium of claim 14, wherein said embedded programming stream is selected from two or more such streams based on at least one of a geographic area and demographics of the subscriber.

16. The computer-readable medium of claim 14, wherein said tracking comprises tracking discrete viewing time segments of duration lesser than a programming content duration, and wherein said allocating comprises allocating a fixed compensation credit for each of said viewing time segments.

17. The computer-readable medium of claim 14, wherein said compensation credit comprises a subscription fee credit to be applied against subscription fees of said given subscriber.

18. The computer-readable medium of claim 14, further comprising periodically monetarily compensating said given subscriber as a function of said allocated compensation credits.

19. An Internet streaming content delivery system comprising:
a user interface to be rendered on a user terminal in providing users selective access to programming content over an IP network in either of an original programming content stream and an embedded programming content stream;
an access management server in communication with said user interface to receive, from a given user terminal, remote selection of given programming content in either of said original programming content stream and said embedded programming content stream;
one or more streaming servers streaming said given programming content to said given user terminal in an embedded format in response to said remote selection being for said embedded programming stream;
one or more encoders operatively coupled to said one or more streaming servers to embed content with said given programming content to be viewed streaming concurrently therewith via said given user terminal;
a view tracker to track said streaming in said embedded format over time to said given user terminal; and
a user account interface to said tracker to incrementally allocate user credits to a user of said given user terminal as a function of said tracked viewing.

20. The system of claim 19, consisting of an IPTV system, wherein said one or more streaming servers comprise a unicast broadcasting system, and wherein said view tracker tracks streaming content pushed to an IP address of said user terminal by said unicast broadcasting system.
